(19) United States
(12) Patent Application Publication
(10) Pub. No.: US 2009/0240638 A1
(43) Pub. Date: Sep. 24, 2009

(54) SYNTACTIC AND/OR SEMANTIC ANALYSIS OF UNIFORM RESOURCE IDENTIFIERS

(75) Inventors: Alok S. Kirpal, Bangalore (IN); Krishna Lecla Poola, Bangalore (IN); Kirshna Prasad Chitrapura, Bangalore (IN)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/051,729

(22) Filed: Mar. 19, 2008

(51) Int. Cl. G06F 17/30; G06F 15/18

(52) U.S. Cl. 706/12; 707/104.1; 707/E17.009

(57) ABSTRACT

Subject matter disclosed herein may relate to analyses of uniform resource identifiers associated with web pages, and further may relate to gathering information about web pages by analyzing the uniform resource identifiers.

### FIELD

Subject matter disclosed herein may relate to the analysis of uniform resource identifiers associated with web pages.

### BACKGROUND

The Internet is a worldwide system of computer networks and is a public, self-sustaining facility that is accessible to tens of millions of people worldwide. The most widely used part of the Internet is the World Wide Web, often abbreviated “WWW” or simply referred to as just “the web”. The web is an Internet service that organizes information through the use of hypermedia. The HyperText Markup Language (“HTML”) is typically used to specify the contents and format of a hypermedia document (e.g., a web page).

Through the use of the web, individuals have access to millions of pages of information. However a significant drawback with using the web is that because there is so little organization, at times it can be extremely difficult for users to locate the particular pages that contain the information that is of interest to them. To address this problem, “search engines” have been developed to index a large number of web pages and to provide an interface that can be used to search the indexed information by entering certain words or phases to be queried.

Search engines may generally be constructed using several common functions. Typically, each search engine has one or more at least one “web crawlers” (also referred to as “crawler”, “spider”, “robot”) that “crawls” across the Internet in a methodical and automated manner to locate web documents around the world. Upon locating a document, the crawler stores the document's uniform resource locator (URL), and follows any hyperlinks associated with the document to locate other web documents. Also, each search engine may include information extraction and indexing mechanisms that extract and index certain information about the documents that were located by the crawler. In general, index information is generated based on the contents of the HTML file associated with the document. The indexing mechanism stores the index information in large databases that can typically hold an enormous amount of information. Further, each search engine provides a search tool that allows users, through a user interface, to search the databases in order to locate specific documents, and their location on the web (e.g., a URL), that contain information that is of interest to them.

With the advent of e-commerce, many web pages are dynamic in their content. Typical examples are products sold at discounted prices that change periodically, or hotel rooms that may change their room fares on a seasonal basis. Therefore, it may be desirable to update crawled content on frequent and near realtime bases.

Information Extraction (IE) systems may be used to gather and manipulate the unstructured and semi-structured information on the web and populate backend databases with structured records. Such systems may face difficulties due to the complexity and variability of the large numbers of web pages from which information is to be gathered. Such systems may require a great deal of cost, both in terms of computing resources and time. Also, relatively large expenses may be incurred in some situations by the need for human intervention during the information extraction process.

### BRIEF DESCRIPTION OF THE FIGURES

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 is a block diagram depicting an example system including an example embodiment of an information extraction platform;

FIG. 2 is a flow diagram of an example embodiment of a process for determining one or more characteristics of a web page by analyzing URL information;

FIG. 3 is a block diagram depicting an example URL and a plurality of tokens gleamed from the URL;

FIG. 4 is a flow diagram of an example embodiment of a process for determining a category of a web page by analyzing URL information;

FIG. 5 is a flow diagram of another example embodiment of a process for determining one or more characteristics of a web page by analyzing URL information;

FIG. 6 is a block diagram of an example computing system in accordance with an embodiment; and

FIG. 7 is a block diagram of an example information integration system in accordance with an embodiment.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of claimed subject matter. It should also be noted that directions and references, for example, up, down, top, bottom, and so on, may be used to facilitate the discussion of the drawings and are not intended to restrict the application of claimed subject matter. Therefore, the following detailed description is not to be taken in a limiting sense and the scope of claimed subject matter defined by the appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Embodiments claimed may include one or more apparatuses for performing the operations herein. These apparatuses may be specially constructed for the desired purposes, or they may comprise a general purpose computing platform selectively activated and/or reconfigured by a program stored in the device. The processes and/or displays presented herein are not inherently related to any particular computing platform and/or other apparatus. Various general purpose computing platforms may be used with programs in accordance with the teachings herein, or it may prove convenient to construct a more specialized computing platform to perform the desired method. The desired structure for a variety of these computing platforms will appear from the description below.

Embodiments claimed may include algorithms, programs, processes, and/or symbolic representations of operations on data bits or binary digital signals within a computer memory capable of performing one or more of the operations described herein. Although the scope of claimed subject matter is not limited in this respect, one embodiment may be in hardware, such as implemented to operate on a device or combination of devices, whereas another embodiment may be in software. Likewise, an embodiment may be implemented in firmware, or as any combination of hardware, software, and/or firmware, for example. These algorithmic descriptions and/or representations may include techniques used in the data processing arts to transfer the arrangement of a computing platform, such as a computer, a computing system, an electronic computing device, and/or other information handling system, to operate according to such programs, algorithms, and/or symbolic representations of operations. A program and/or process generally may be considered to be a self-consistent sequence of acts and/or operations leading to a desired result. These include physical manipulations of physical quantities. Usually, though not necessarily, these quantities take the form of electrical and/or magnetic signals capable of being stored, transferred, combined, compared, and/or otherwise manipulated. It has proven convenient at times, principally for reasons of common usage, to refer to these signals as bits, values, elements, symbols, characters, terms, numbers and/or the like. It should be understood, however, that all of these and/or similar terms are to be associated with the appropriate physical quantities and are merely convenient labels applied to these quantities. In addition, embodiments are not described with reference to any particular programming language. It will be appreciated that a variety of programming languages may be used to implement the teachings described herein.

Likewise, although the scope of claimed subject matter is not limited in this respect, one embodiment may comprise one or more articles, such as a storage medium or storage media. This storage media may have stored thereon instructions that when executed by a computing platform, such as a computer, a computing system, an electronic computing device, and/or other information handling system, for example, may result in an embodiment of a method in accordance with claimed subject matter being executed, for example. The terms “storage medium” and/or “storage media” as referred to herein relate to media capable of maintaining expressions which are perceivable by one or more machines. For example, a storage medium may comprise one or more storage devices for storing machine-readable instructions and/or information. Such storage devices may comprise any one of several media types including, but not limited to, any type of magnetic storage media, optical storage media, semiconductor storage media, disks, floppy disks, optical disks, CD-ROMs, magnetic-optical disks, read-only memories (ROMs), random access memories (RAMs), electrically programmable read-only memories (EPROMs), electrically erasable and/or programmable read-only memories (EEPROMs), flash memory, magnetic and/or optical cards, and/or any other type of media suitable for storing electronic instructions, and/or capable of being coupled to a system bus for a computing platform. However, these are merely examples of a storage medium, and the scope of claimed subject matter is not limited in this respect.

The term “instructions” as referred to herein relates to expressions which represent one or more logical operations. For example, instructions may be machine-readable by being interpretable by a machine for executing one or more operations on one or more data objects. However, this is merely an example of instructions, and the scope of claimed subject matter is not limited in this respect. In another example, instructions as referred to herein may relate to encoded commands which are executable by a processor having a command set that includes the encoded commands. Such an instruction may be encoded in the form of a machine language understood by the processor. For an embodiment, instructions may comprise run-time objects, such as, for example, Java and/or Javascript objects. However, these are merely examples of an instruction, and the scope of claimed subject matter is not limited in this respect.

Unless specifically stated otherwise, as apparent from the following discussion, it is appreciated that throughout this specification discussions utilizing terms such as processing, computing, calculating, selecting, forming, enabling, inhibiting, identifying, initiating, receiving, transmitting, determining, estimating, incorporating, adjusting, modeling, displaying, sorting, applying, varying, delivering, appending, making, presenting, distorting and/or the like refer to the actions and/or processes that may be performed by a computing platform, such as a computer, a computing system, an electronic computing device, and/or other information handling system, that manipulates and/or transforms data represented as physical electronic and/or magnetic quantities and/or other physical quantities within the computing platform's processors, memories, registers, and/or other information storage, transmission, reception and/or display devices. Further, unless specifically stated otherwise, processes described herein, with reference to flow diagrams or otherwise, may also be executed and/or controlled, in whole or in part, by such a computing platform.

Reference throughout this specification to “one embodiment” or “an embodiment” means that a particular feature, structure, or characteristic described in connection with the embodiment is included in at least one embodiment of claimed subject matter. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “and/or” as referred to herein may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

As discussed above, information extraction systems may face difficulties due to the complexity and variability of the enormous numbers of web pages from which information may be gathered. Such systems may require a great deal of cost, both in terms of resources and time.

Embodiments disclosed herein may comprise syntactic and /or semantic analysis of uniform resource identifiers (URI), including, but not limited to, uniform resource locators (URL), by considering the information contained in the URI without actually examining the contents of the web page associated with the URI. For example, a web site may contain web pages that include shopping content and may also contain web pages that include travel content. Assume for this example that it is desired to crawl the shopping related pages. For one or more embodiments, the URI for each page may be analyzed to determine whether the page associated with each URI falls into the shopping category. Thus, the crawling operation can be readily limited to the shopping pages only, without having to examine the contents of all of the pages of this example web site. For embodiments described herein, URLs are discussed. However, as mentioned above, claimed subject matter is not restricted to URLs. URL is merely an example identifier type, and other embodiments are possible related to other types of URI.

In general, an embodiment of a process for more efficiently gathering information from a plurality of electronic documents, such as web pages, for example, may comprise gathering the web page information from one or more URIs associated with one or more web sites. As used herein, the term “uniform resource identifier” is meant to include any electronic object that identifies a resource on a network and that includes information for locating the resource. URIs may be said to act as references to web pages on the Internet, for example. By gathering information from URIs, rather than by examining the actual contents of the web page to which the URI is associated, significant time and resource savings may be achieved. As mentioned above, one example of a URI is a URL. Therefore, although the example embodiments described herein discuss URLs, the scope of claimed subject matter is not so limited, and one or more of the example embodiments described herein may be utilized in connection with any URI.

In one or more embodiments, to gather information from a URL, the URL may undergo a type of syntactic analysis referred to herein as “tokenization.” That is, the URL may be parsed into various tokens that may represent various types of information, as discussed more fully below. The information provided by the tokens may directly provide information about the web page associated with the URL, and/or may provide pointers to information that may be stored in one more “catalogues”. Tokens from a URL may explicitly mention keywords regarding the web page to which the URL refers, and/or may include information made implicit through. For example, a URL may include the token “electronics” as an explicit keyword, while another URL may include a code such as “11034” that may represent the keyword “electronics.”

In an embodiment, one or more catalogues (databases) may store information regarding associations between tokens and labels. For example, a catalogue may contain the label “electronics” and may also store the token “11034” as well as an indication that “111034” is associated with “electronics”. In this manner, whenever a URL is examined that includes the token “11034”, a lookup may be performed to determine the value associated with the token, which, in this example, is the category “electronics.” Also, for one or more embodiments, information stored in the catalogue may be produced by examining a subset of web pages. For example, a relatively small number of web pages from the example web site may be examined to generate tokens, labels, and associations between the tokens and labels. For this example, the token “11034” may have been identified as being associated with the category “electronics” by analyzing one or more of the subset of pages.

For one or more embodiments, a sequence modeling process may be utilized to tokenize the URL and to identify labels that may be associated with the tokens. For one or more embodiments, the sequence modeling process may comprise a machine learning process that may be utilized to segment the URL into the plurality of tokens. The tokens may be associated with one or more labels that may correspond to one or more predefined classes, as is explained in more detail below. One or more characteristics of the web page may be determined based on the one or more labels without inspecting the actual web page contents. URLs may lend themselves to sequence modeling processes such as those discussed herein at least in part due to the sequential nature of the URLs. For example, a URL of http://abcd.com/Electronics/lpod may convey a sequence comprising a first static component of a first level category of “Electronics” and a second static component “Ipod” which, for this example, comprises a sub-category of “Electronics.”

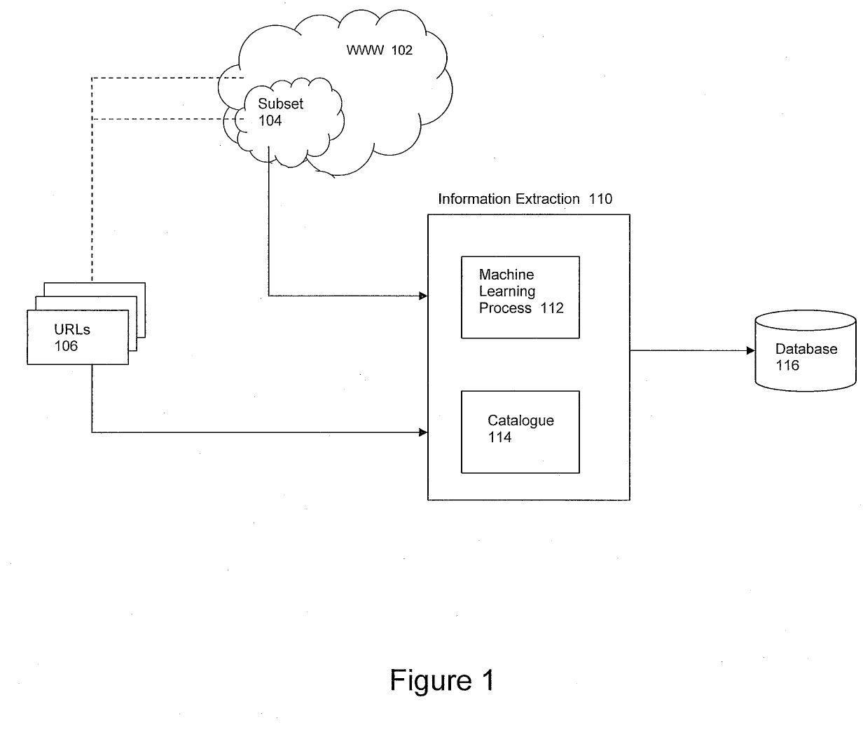

FIG. 1 is a block diagram depicting an example system including an example embodiment of an information extraction platform 110. Information extraction platform 110 may comprise a machine learning process 112 and a catalogue 114. Information extraction platform 110 may operate to crawl the world wide web 102 in order to gather information that may be used for a wide range of purposes, including, but not limited to, providing information for search engine databases, or for targeting advertising to appropriate audiences, etc.

Machine learning process 112 may be trained using information gathered from a subset 104 of websites from www 102. To train the machine learning process, the contents of the web pages from subset 102 may be analyzed to gleam information that may be stored in catalogue 114. Machine learning process 112 may segment one or more URLs 106 corresponding to pages from subset 104 to produce tokens that may be associated with one or more labels that may represent various types of information, such as, for example and not by way of limitation, domain names, web site classifications, product categories, product types, product identifiers, etc. Catalogue 114 may store tokens and labels, as well as information regarding associations between the tokens and the labels. The associations between the tokens and the labels may be discovered by examining the contents of the web pages from subset 104. The information stored in catalogue 114 may be utilized by machine learning process 112 to determine values for unknown labels corresponding to tokens from URLs from www 102 that were not part of the training set (subset 104). In this manner, a relatively small number of web pages may be examined and analyzed to enable information extraction platform 110 to determine information regarding a wide range of web pages from www 102 without actually examining the contents of the web pages, but rather by analyzing the URLs associated with the web pages. Information extraction platform 110 may store the information gleamed from the web pages in a database 116 in one or more embodiments. The embodiment described in connection with FIG. 1 is merely an example embodiment, and the scope of claimed subject matter is not limited in this respect.

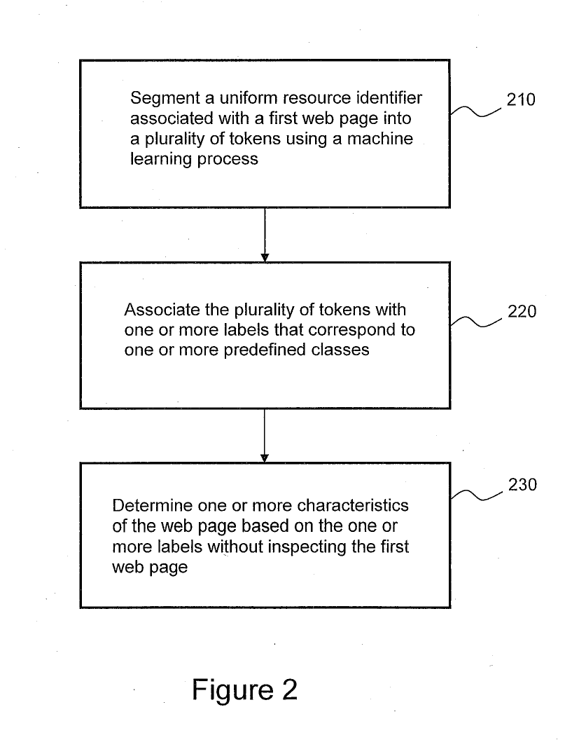

FIG. 2 is a flow diagram of an example embodiment of a process for determining one or more characteristics of a web page by analyzing URI information, without inspecting the web page associated with the URI. Information may be utilized from a training set gleamed from analyzing a relatively small subset of web pages from a larger group of web pages to determine characteristics of the web page associated with the URI. At block 210, a URI associated with a first web page may be segmented into a plurality of tokens using a machine learning process. For one or more embodiments, the machine learning process may comprise a Conditional Random Fields (CRF) process, although the scope of claimed subject matter is not limited in this respect. In general, CRFs comprise a probabilistic framework for labeling and segmenting sequential data, based on a conditional model. The conditional model may be used to label a novel observation sequence “x” by selecting a label sequence “y” that maximizes the conditional probability of p(x|y). In one or more embodiments, the CRFs may comprise linear chain CRFs, although, again, the scope of claimed subject matter is not limited in this respect. Linear chain CRFs may capture the sequential dependency between adjacent tokens for a URI.

At block 220, the plurality of tokens may be associated with one or more labels that may correspond to one or more predefined classes. For one or more embodiments, possible class labels may comprise domain names, class (e.g., Shopping, Travel, etc.), category (e.g., Electronics, Apparel, Dining, Sporting Goods, Music, etc.), category-id (perhaps a merchant specific category identifier), entity (e.g., product, hotel, etc.), and/or entity-id (perhaps a merchant specific entity identifier). These are merely examples of possible labels and classes, and the scope of claimed subject matter is not limited in this respect.

For one or more embodiments, the URL may be tokenized by the machine learning process based, at least in part, on a predefined set of delimiters. Such delimiters may include, but are not limited to, ‘/’, ‘&’, ‘?’, ‘_’, ‘-’ , ‘=’, etc. The delimiters themselves may be referred to as tokens. The delimiter tokens aid in identifying class boundaries. For an embodiment, tokens may be associated with one or more features. These features may comprise observed characteristics of one or more URLs. Different types of features may be defined that may aid in the segmentation process. Such feature types may include “dictionary” based features. The dictionary based features may comprise values for tokens that may be stored in a catalogue and retrieved upon a look-up into the catalogue. Regular expression based features may also comprise a feature type. Token features may also be included, as well as transition features. The transition features may comprise characteristics of URLs that may be observed in transitioning from one category to another in the URLs of a web site, for example. The feature types may also comprise “context” features. However, these are merely examples of feature types that may be associated with tokens, and the scope of claimed subject matter is not limited in this respect.

At block 230, one or more characteristics of the web page may be determined based on the one or more labels without inspecting the first web page. Example processes in accordance with claimed subject matter may include all, more than all, or less than all of blocks 210-230. Further, the order of blocks 210-230 is merely an example order, and claimed subject matter is not limited in these respects.

For one embodiment, the information extraction process may be referred to as a “generic” technique, wherein the URL analyses is meant to be valid across the entire Web. The machine learning training for this example may be based on a number of URLs and associated websites that represent a subset of web pages from across the Web, and the learning from the training may be applied to analyze URLs associated with any web site from across the Web. Such an approach may not yield as detailed an analysis as would otherwise be available if the training is based on a more targeted subset of web pages.

For an example, assume that the URLs from two major search engines are analyzed as part of a machine learning process training operation. For this example, the first URL comprises

“http://www.google.com/search?hl=en&client=firefox-a&rls=org.mozilla%3Aen-US%3Aofficiai&hs=fyd&q=tommy+hilfiger&btnG=Search&meta=” and the second URL comprises

“http://search.yahoo.com/search;_ylt=A0geu8WypU9HwtkAWmOI87UF?p=tommy+hilfiger&ei=UTF-8&iscqry=&fr=sfp”.

From the above example URLs, it can be seen that google.com uses the query key “q” for specifying the query ‘tommy hilfiger’ while yahoo.com used the query key ‘p’ to represent the same. Such learning information may be utilized in analyzing future URLs. For example, assume that the two above URLs and perhaps, although not necessarily, the web pages associated with the URLs are used as part of a training operation for the machine learning process. Given a new URL from another search engine, for example, the label identifying the search query key may be identified based at least in part on the search query key information gleamed from the example google.com and yahoo.com URLs. For example, the new URL (the URL to be analyzed) may comprise “http://youtube.com/results?search_query=tommy+hilfiger&search=Search”. As can be seen by examining the example google.com and yahoo.com URLs, the label “tommy hilfiger” is associated with the search query key. Therefore, for this example, the machine learning process may determine that the token “search_query” from the new URL is associated with the search query key label in at least much the same way that the labels ‘q’ and ‘p’ are associated with the search query key labels in the google.com and yahoo.com URLs, respectively, as described above.

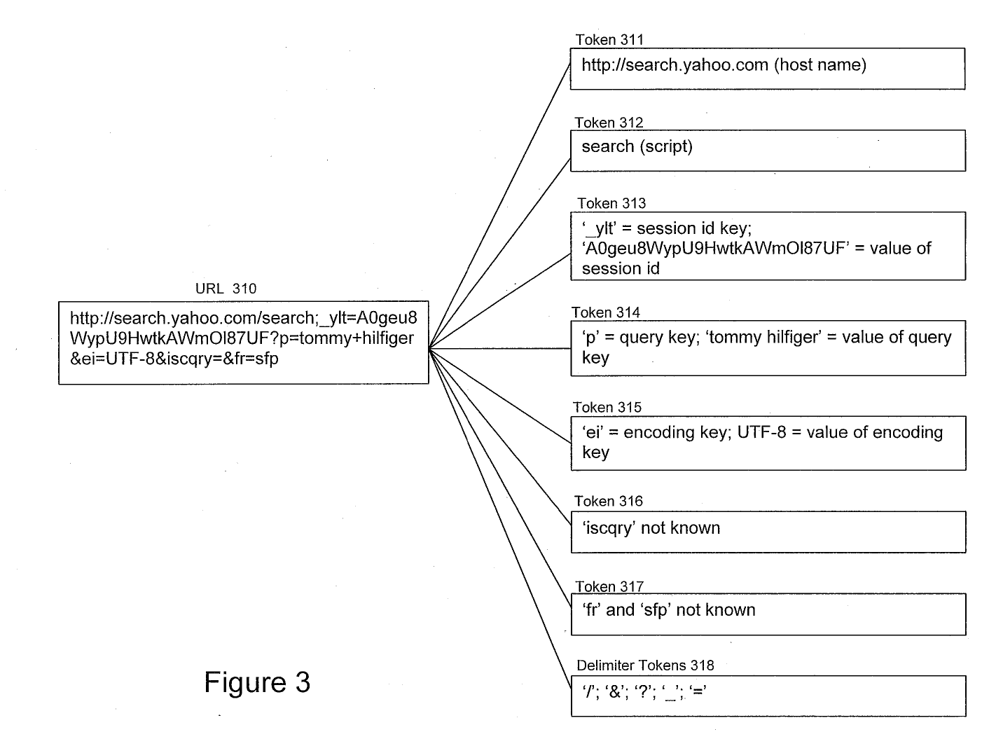

FIG. 3 is a block diagram depicting an example URL 310 and a plurality of tokens 311-318 gleamed from URL 310. For this example, URL 310 comprises

“http://search.yahoo.com/search;_ylt=A0geu8WypU9HwtkAWmOI87UF?p=tommy+hilfiger&ei=UTF-8&iscqry=&fr=sfp”

For this example, a machine learning process may segment URL 310 into a number of tokens. As previously mentioned, for one or more embodiments the machine learning process may utilize sequence models such as, for example, CRF. However, CRF is merely one of many sequence models in the machine learning art and the scope of claimed subject matter extends to other sequence models.

Token 311 for this example comprises “http://search.yahoo.com”, and includes the host (domain) name of the web page. Token 312 comprises the token “search” which, for this example, denotes a type of script. Token 313 includes a session id key “_ylt” and the value of the session id key which, for this example, comprises the value “A0geu8WypU9HwtkAWmOI87UF”. Also for this example, token 314 comprises a query key “p”, as well as the value of the query key “tommy hilfiger”.

Token 315 includes an encoding key ‘ei’ as well as the value of the encoding key which, for this example, comprises “UTF-8”. Token 316 includes the value of “iscqry” which, for this example, is not known. That is, the machine learning process was not able to discern the semantics of this particular token. In such a case, for one or more embodiments, either the value may remain unknown, or, if desired, the web page associated with URL 310 may be analyzed to determine the meaning of the unknown token. For this example, token 317 includes the unknown values “fr” and “sfp”. As can be seen by reference to URL 310, the URL 310 comprises a number of delimiter tokens 318, which, for this example, comprise the delimiters ‘/’; ‘&’; ‘?’; ‘_’; and ‘=’. Of course, URL 310 is merely an example URL, and the scope of claimed subject matter is not limited in this respect. Similarly, tokens 311 through 318 are merely example tokens that represent an example segmentation of URL 310, and the scope of claimed subject matter is not limited in these respects.

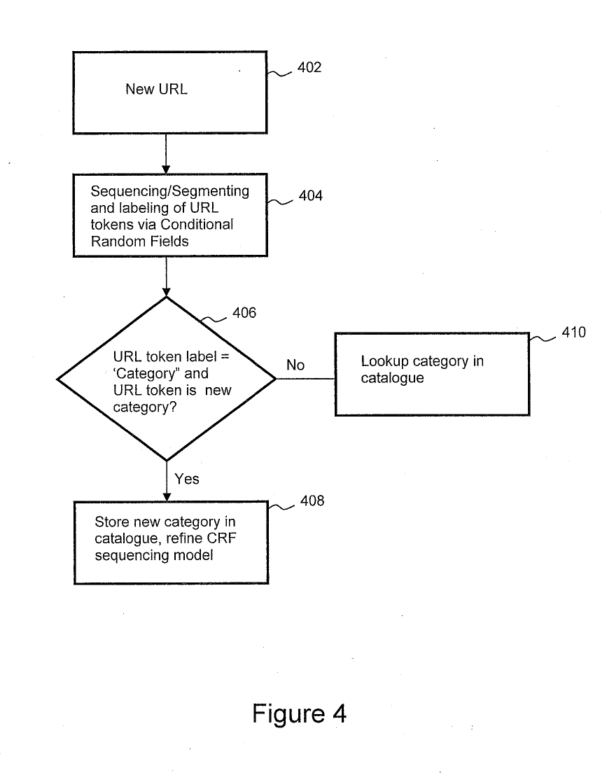

FIG. 4 is a flow diagram of an example embodiment of a process for determining a category of a web page by analyzing URL information. For this example, a new URL (the URL to be analyzed) may be received at block 402. At block 404, the URL may undergo sequencing and/or segmentation and/or labeling processing using CRF as discussed previously. As previous mentioned, CRF is merely an example sequencing model and/or machine learning process, and the scope of claimed subject matter is not limited in this respect. At block 406, a determination may be made as to whether the CRF process yielded a token that may represent an as yet unidentified category and/or class. If the token has been previously identified (that is, for example, previous training operations provided information related to the token), at 410 a look-up may be performed into a catalogue that may have stored therein label and/or feature information associated with the token. If, however, it is determined at 406 that the token has not been previously identified, that is, the token represents a new category, the new category may be stored in the catalogue along with any other label and/or feature information associated with the token. For one or more embodiments, in the case of a new category, the web page associated with the new URL may be examined to gather information associated with the new category. The new category and/or the information gleamed from examining the web page may be added to the training information utilized by the CRF. In other words, the CRF sequencing model may be refined to incorporate the additional information from the new URL and its associated web page. Example processes in accordance with claimed subject matter may include all, more than all, or less than all of blocks 402-408. Further, the order of blocks 402-408 is merely an example order, and claimed subject matter is not limited in these respects.

As discussed above, for one embodiment the URL analysis process may be intended to comprise a generic process that may be utilized across the Web. In the case of a generic process, the universe of web pages under consideration may comprise the entire Web, with a subset of those web pages selected for training the machine learning process. In order to provide more detailed analyses of URLs, other “site-specific” embodiments may be implemented. For a site-specific embodiment, the total universe of web pages under consideration may comprise web pages from a single web site. In other embodiments, more than one web site may be included, although the number of web sites for these embodiments may be relatively small as compared to the entire Web. The subset of web pages used for training purposes may, for this example, be selected from the single web site or from the relatively small number of web sites, depending on the specific embodiment. The training operations may comprise analyzing the subset of URLs and may also comprise examining the contents of the web pages to which the subset of URLs are associated. Information gathered through the training process may be stored in one or more catalogues (databases).

Classifiers may be utilized during training operations to identify categories of web pages. For example, consider the URL “http://www.rocawear.com/nshop/product.php?view=listing&groupName=mjeans &dept=men”. For this example, a first classifier may identify various class labels for the URL. In this case, the first classifier may associate the class label “shopping” with this URL. A second classifier may identify categories and/or sub-categories for the URL. For this example, the second classifier may associate the category and sub-category labels “apparel, mens” with the URL. A third classifier may identify entity labels for the URL. The entity labels may comprise “final” and/or “listings” labels. The “final” label may indicate a single entity (for example, a single product), and the “listings” label may denote a page with multiple entities (perhaps products, for an example) listed. Of course, this classification scheme is merely an example, and the scope of claimed subject matter is not limited in these respect.

For the example embodiments currently under discussion, the URLs that are used for training purposes (the subset of URLs) may be crawled, and the content of the web pages associated with the subset of URLs may be examined to gather semantic information that may be associated with the URLs. Once training is complete, new URLs may be analyzed without examining the contents of the web pages associated with the new URLs.

Also for an embodiment, URL tokens and semantic information may be processed by an association rule learning process to find associations between the URL tokens and the semantic information. As used herein, the term “semantic information” is meant to include any information that may characterize, at least in part, one or more tokens. Such information may include, by way of non-limiting example and not by limitation, labels, features, classes, categories, entities, domains, etc. Association rule learning, if given a number of transactions to analyze, may identify associations between different items in the transactions. For the embodiments disclosed herein, a transaction may be represented as URL tokens along with the semantic information. The association rule learning process may assign semantic information to one or more tokens- in a URL token sequence, and this information may be used to train a sequence model such as, for example, a CRF process.

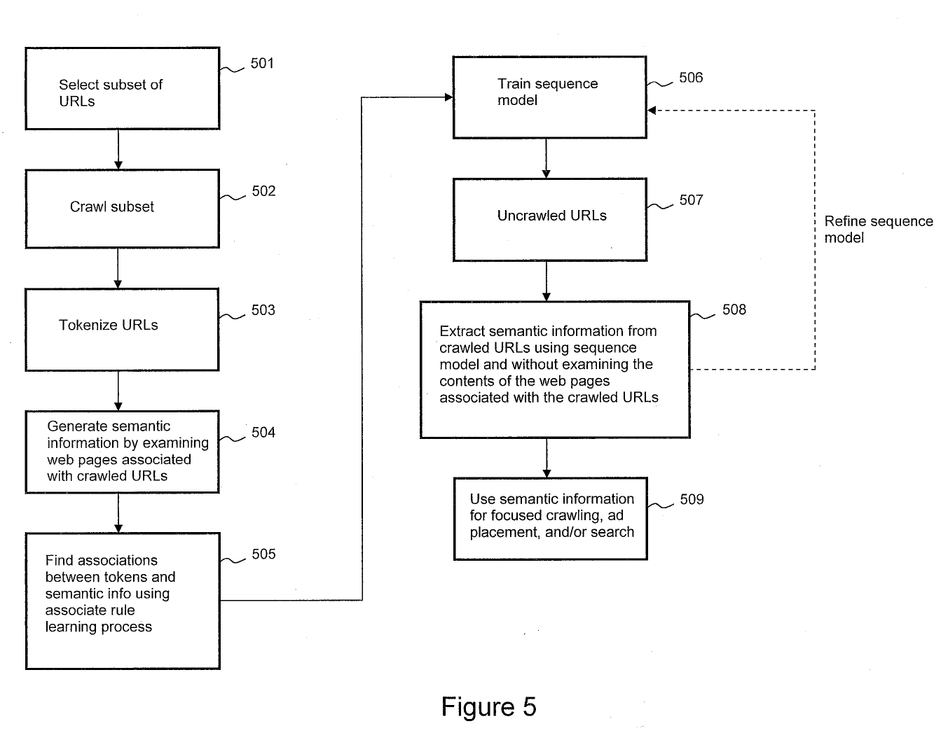

FIG. 5 is a flow diagram of another example embodiment of a process for determining one or more characteristics of a web page by analyzing URL information. At block 501, a subset of URLs may be selected from a larger group of URLs. For one or more embodiments, the larger group of URLs may represent web pages from the entire Web, and the subset of URLs may represent a smaller number of web pages from a variety of locations across the Web. For another embodiment, the larger group of URLs may represent web pages from a single web site, and the subset of URLs may represent a sampling of web pages from that web site. By limiting the universe of web pages to one web site, or, for another embodiment, a relatively small number of web sites, more focused and more detailed analyses may be performed.

At block 502, the subset of URLs may be crawled, and the subset of URLs may be tokenized at block 503. The tokenization process may segment the URL into a plurality of tokens, such as, for example, discussed previously. At block 504, semantic information may be generated by examining web pages associated with the crawled URLs. For one or more embodiments, classifiers such as those discussed above may be utilized to identify at least a portion of the semantic information. At block 505, associations between the tokens and the semantic information may be found. For an embodiment, the associations may be found using an association rule learning process.

Information from the association rule learning process may be utilized, at least in part, to train a sequence model at block 506. For this example embodiment, information from the association rule learning process may comprise information regarding associations between the tokens and the semantic information. Also for this example embodiment, the sequence model may comprise a CRF linear chain model. At block 507, URLs from a larger group of web pages may be processed, and at 508, information may be extracted from the uncrawled URLs without examining the contents of the web pages associated with the crawled URLs. At points during the information extraction process, information may be obtained that may permit the sequence model to be refined. For example, as described previously, information regarding newly identified categories may be folded back into the sequence model to improve the sequence model's ability to identify categories. Such semantically associated URLs may be used in a wide range of Web applications such as, for example: “Focused crawling”, where it may be desirable to gather pages related to a given topic; “Contextual advertisement”, where it may be desirable to place advertisements on a Web page by merely looking at the page's URL; and “Search”, where it may be desirable to retrieve pages based on categories and/or topics associated with URL tokens. See, for example, block 509. Example processes in accordance with claimed subject matter may include all, more than all, or less than all of blocks 501-509. Further, the order of blocks 501-509 is merely an example order, and claimed subject matter is not limited in these respects.

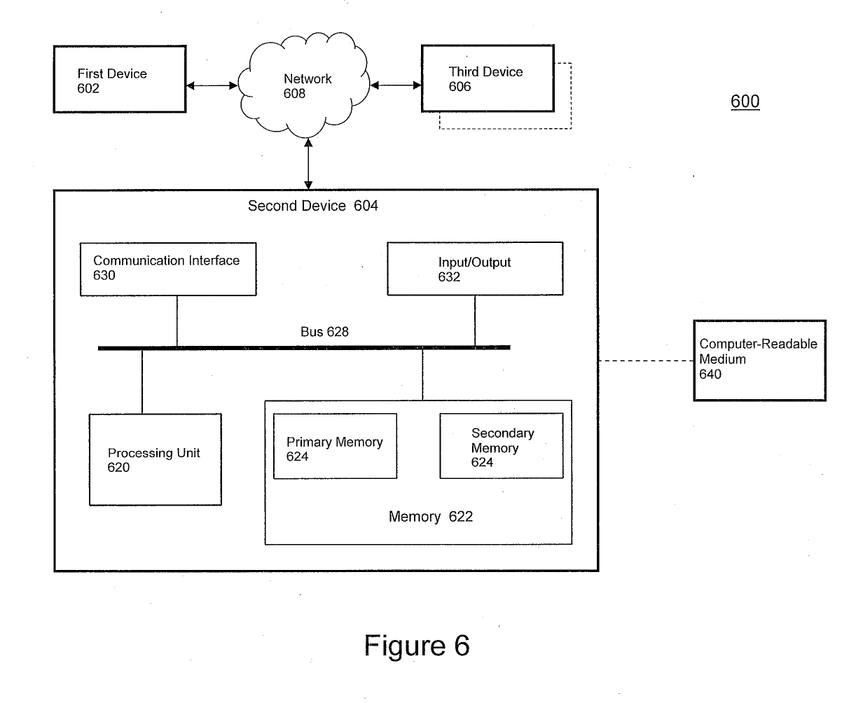

FIG. 6 is a block diagram of an exemplary embodiment of a computing environment system 600 that may include one or more devices configurable to and/or that may be directed to determine one or more characteristics of a URL or its associated web page using one or more techniques illustrated above, for example. System 600 may include, for example, a first device 602, a second device 604, and a third device 606, which may be operatively coupled together through a network 608.

First device 602, second device 604 and third device 606, as shown in FIG. 6, may be representative of any device, appliance or machine that may be configurable to exchange data over network 608. By way of example but not limitation, any of first device 602, second device 604, or third device 606 may include: one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

Similarly, network 608, as shown in FIG. 6, is representative of one or more communication links, processes, and/or resources configurable to support the exchange of data between at least two of first device 602, second device 604, and third device 606. By way of example but not limitation, network 608 may include wireless and/or wired communication links, telephone or telecommunications systems, data buses or channels, optical fibers, terrestrial or satellite resources, local area networks, wide area networks, intranets, the Internet, routers or switches, and the like, or any combination thereof. As illustrated, for example, by the dashed lined box illustrated as being partially obscured of third device 606, there may be additional like devices operatively coupled to network 608.

It is recognized that all or part of the various devices and networks shown in system 600, and the processes and methods as further described herein, may be implemented using or otherwise include hardware, firmware, software, or any combination thereof.

Thus, by way of example but not limitation, second device 604 may include at least one processing unit 620 that is operatively coupled to a memory 622 through a bus 628.

Processing unit 620 is representative of one or more circuits configurable to perform at least a portion of a data computing procedure or process. By way of example but not limitation, processing unit 620 may include one or more processors, controllers, microprocessors, microcontrollers, application specific integrated circuits, digital signal processors, programmable logic devices, field programmable gate arrays, and the like, or any combination thereof.

Memory 622 is representative of any data storage mechanism. Memory 622 may include, for example, a primary memory 624 and/or a secondary memory 626. Primary memory 624 may include, for example, a random access memory, read only memory, etc. While illustrated in this example as being separate from processing unit 620, it should be understood that all or part of primary memory 624 may be provided within or otherwise co-located/coupled with processing unit 620.

Secondary memory 626 may include, for example, the same or similar type of memory as primary memory and/or one or more data storage devices or systems, such as, for example, a disk drive, an optical disc drive, a tape drive, a solid state memory drive, etc. In certain implementations, secondary memory 626 may be operatively receptive of, or otherwise configurable to couple to, a computer-readable medium 640. Computer-readable medium 640 may include, for example, any medium that can carry and/or make accessible data, code and/or instructions for one or more of the devices in system 600.

Second device 604 may include, for example, a communication interface 630 that provides for or otherwise supports the operative coupling of second device 604 to at least network 608. By way of example but not limitation, communication interface 630 may include a network interface device or card, a modem, a router, a switch, a transceiver, and the like.

Second device 604 may include, for example, an input/output 632. Input/output 632 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 632 may include an operatively configured display, speaker, keyboard, mouse, trackball, touch screen, data port, etc.

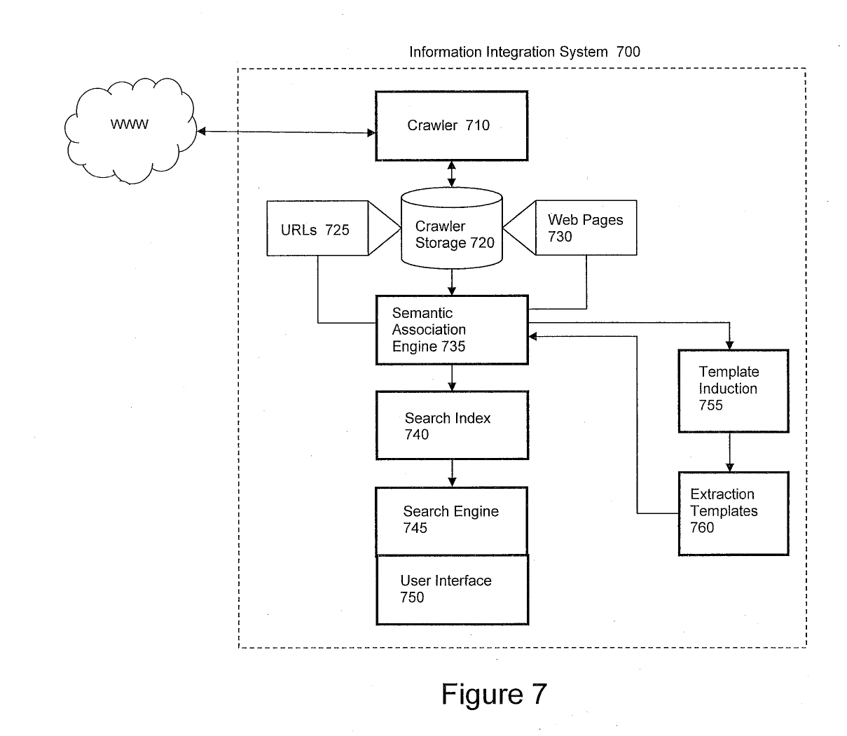

FIG. 7 is a block diagram of an example information integration system (IIS) 700 in accordance with an embodiment. The context in which an IIS may be implemented may vary. By way of non-limiting examples, an IIS such as IIS 700 may be implemented for public or private search engines, job portals, shopping search sites, travel search sites, RSS (Really Simple Syndication) based applications and sites, and the like. Embodiments are described herein primarily in the context of a World Wide Web (WWW) search system, for purposes of an example. However, the scope of claimed subject matter is not limited to these examples. Embodiments are possible where the implementation is not limited to Web search systems. For example, embodiments may be implemented in the context of private enterprise networks (e.g., intranets), as well as the public network of networks (i.e., the Internet), although, again, the scope of claimed subject matter is not limited in these respects.

IIS 700 may comprise a crawler 710 communicatively coupled to a source of information, such as the Internet and the World Wide Web (WWW). IIS 700 may further comprise a crawler storage 720, a search engine 745 backed by a search index 740 and associated with a user interface 750.

A web crawler (also referred to as “crawler”, “spider”, “robot”), such as crawler 710, may operate to “crawl” across the Internet in a methodical and automated manner to locate web pages around the world. Upon locating a page, the crawler may store the page's URL in URLs 725, and may follow any hyperlinks associated with the page to locate other web pages. The crawler may also stores entire web pages 730 (e.g., HTML and/or XML code) and URLs 725 in crawler storage 720. Use of this information, according to embodiments of the invention, are described in greater detail herein.

Search engine 745 generally refers to a mechanism that may be used to index and search a large number of web pages, and may be used in conjunction with user interface 750 that may be used by a user to search the search index 740 by entering certain words or phases to be queried. In general, the index information stored in search index 740 may be generated based on extracted contents of the HTML file associated with a respective page, for example, as extracted using extraction templates 760 generated by template induction techniques 755. For one or more embodiments, techniques such as those described above for gathering information about web pages through the analysis of URLs may be utilized to extract index information regarding the web pages. Generation of the index information may comprise a main purpose of system 700, and such information may be generated with the assistance of a semantic association engine 735. For example, if crawler 710 is storing all the pages that have job descriptions, semantic association engine 735 may extract useful information from these pages, such as the job title, location of job, experience required, etc. and use this information to index the page in the search index 740. Again, such information may in one or more embodiment be extracted through analysis of URLs, as described previously. One or more search indexes 740 associated with search engine 745 may comprise a list of information accompanied with the location of the information, i.e., the network address of, and/or a link to, the page that contains the information.

As mentioned, extraction templates 760 may be used to facilitate the extraction of desired information from a group of web pages, such as by semantic extraction engine 735. Further, extraction templates 755 may be based on the general layout of the group of pages for which a corresponding extraction template is defined. For example, as previously described, an extraction template may be implemented as an HTML file that describes different portions of a group of pages. Template induction processes 755 may be used to generate extraction templates 760.

Information integration system 700 may be implemented in hardware or software, or in a combination of hardware and software. For example, IIS 700 may be implemented in accordance with second device 604, described above.

It should also be understood that, although particular embodiments have just been described, the claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Such software and/or firmware may be expressed as machine-readable instructions which are executable by a processor. Likewise, although the claimed subject matter is not limited in scope in this respect, one embodiment may comprise one or more articles, such as a storage medium or storage media. This storage media, such as one or more CD-ROMs and/or disks, for example, may have stored thereon instructions, that when executed by a system, such as a computer system, computing platform, or other system, for example, may result in an embodiment of a method in accordance with the claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, the claimed subject matter is not limited in scope to this example.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

What is claimed is:

1. A method, comprising:
segmenting a uniform resource identifier associated with a first web page into a plurality of tokens using a machine learning process;
associating the plurality of tokens with one or more labels that correspond to one or more predefined classes; and
determining one or more characteristics of the web page based on the one or more labels without inspecting the first web page.

2. The method of claim 1, wherein the machine learning process comprises a conditional random fields process.

3. The method of claim 1, further comprising utilizing the determined characteristics of the web page in one or more of a plurality of applications, wherein the plurality of applications comprises at least focused crawling, contextual advertising, and/or web searching.

4. The method of claim 1, wherein said associating said one or more labels to said one or more of the plurality of tokens comprises associating said one or more labels to one or more of the plurality of tokens using said machine learning process.

5. The method of claim 4, wherein said machine learning process comprises an association mining process comprising an association rule making process.

6. The method of claim 1, wherein the one or more predefined classes comprise a domain name.

7. The method of claim 1, wherein the one or more predefined classes comprise a category.

8. The method of claim 7, wherein the one or more predefined classes comprise an entity.

9. The method of claim 8, wherein the one or more predefined classes comprise a category identifier and/or an entity identifier.

10. The method of claim 1, further comprising training the machine learning process using information from a subset of web pages selected from a larger set of web pages associated with one or more web sites.

11. The method of claim 1, wherein said associating comprises determining one or more features of the one or more of the plurality of tokens and further comprises selecting the one or more labels based at least on part on the one or more features.

12. The method of claim 11, wherein said selecting the one or more labels comprises mining a catalogue, wherein the catalogue comprises information regarding associations between a plurality of features including the one or more features and a plurality of labels including the one or more labels.

13. The method of claim 12, further comprising adding a new label to the plurality of labels contained in the catalogue if one or more labels are not found in the catalogue during said selecting said one or more labels based at least in part on said one or more features.

14. The method of claim 13, further comprising refining the machine learning process based at least in part on the new label added to the catalogue.

15. The method of claim 14, wherein the associations between the plurality of features and the plurality of labels comprise associations determined according to an association rule learning process.

16. An article comprising: a storage medium having stored thereon instructions that, if executed, direct a computing platform to:
segment a uniform resource identifier associated with a first web page into a plurality of tokens using a machine learning process;
associate the plurality of tokens with one or more labels that correspond to one or more predefined classes; and
determine one or more characteristics of the web page based on the one or more labels without inspecting the first web page.

17. The article of claim 16, wherein the machine learning process comprises a conditional random fields process.

18. The article of claim 16, wherein the storage medium has stored thereon further instructions that, if executed, further direct the computing platform to utilize the determined characteristics of the web page in one or more of a plurality of applications, wherein the plurality of applications comprises at least focused crawling, contextual advertising, and/or web searching.

19. The article of claim 16, wherein the storage medium has stored thereon further instructions that, if executed, direct the computing platform to associate said one or more labels to said one or more of the plurality of tokens by associating said one or more labels to one or more of the pluralit of tokens using said machine learning process.

20. The article of claim 19, wherein said machine learning process comprises an association mining process comprising an association rule making process.

21. The article of claim 16, wherein the one or more predefined classes comprise a domain name.

22. The article of claim 16, wherein the one or more predefined classes comprise a category and an entity.

23. The article of claim 16, wherein the one or more predefined classes comprise a category identifier and/or an entity identifier.

24. The article of claim 16, wherein the storage medium has stored thereon further instructions that, if executed, direct the computing platform to train the machine learning process using information from a subset of web pages selected from a larger set of web pages associated with one or more web sites.

25. The article of claim 16, wherein the storage medium has stored thereon further instructions that, if executed, direct the computing platform to associate said one or more labels to said one or more of the plurality of tokens by, at least in part, determining one or more features of the one or more of the plurality of tokens and by selecting the one or more labels based at least on part on the one or more features.

26. The article of claim 25, wherein the storage medium has stored thereon further instructions that, if executed, direct the computing platform to select the one or more labels by mining a catalogue, wherein the catalogue comprises information regarding associations between a plurality of features including the one or more features and a plurality of labels including the one or more labels.

27. The article of claim 26, wherein the storage medium has stored thereon further instructions that, if executed, direct the computing platform to add a new label to the plurality of labels contained in the catalogue if one or more labels are not found in the catalogue during said selecting said one or more labels based at least in part on said one or more features.

28. The article of claim 27, wherein the storage medium has stored thereon further instructions that, if executed, direct the computing platform to refine the machine learning process based at least in part on the new label added to the catalogue.

29. The article of claim 28, wherein the associations between the plurality of features and the plurality of labels comprise associations determined according to an association rule learning process.

30. An apparatus, comprising:
means for segmenting a uniform resource identifier associated with a first web page into a plurality of tokens using a machine learning process;
means for associating the plurality of tokens with one or more labels that correspond to one or more predefined classes; and
means for determining one or more characteristics of the web page based on the one or more labels without inspecting the first web page.

31. The apparatus of claim 30, wherein said means for associating said one or more labels to said one or more of the plurality of tokens comprises means for associating said one or more labels to one or more of the plurality of tokens using said machine learning process.

32. The apparatus of claim 30, wherein the one or more predefined classes comprise a domain name and a category.

33. The apparatus of claim 30, further comprising means for training the machine learning process using information from a subset of web pages selected from a larger set of web pages associated with one or more web sites.

34. The apparatus of claim 33, wherein said means for associating comprises means for determining one or more features of the one or more of the plurality of tokens and further comprises means for selecting the one or more labels based at least on part on the one or more features.

35. The apparatus of claim 34, wherein said means for selecting the one or more labels comprises means for mining a catalogue, wherein the catalogue comprises information regarding associations between a plurality of features including the one or more features and a plurality of labels including the one or more labels.

36. The apparatus of claim 30, further comprising means for utilizing the determined characteristics of the web page in one or more of a plurality of applications, wherein the plurality of applications comprises at least focused crawling, contextual advertising, and/or web searching.
